(19) United States
(12) Patent Application Publication
(10) Pub. No.: US 2025/0306440 A1
(43) Pub. Date: Oct. 2, 2025

(54) CAMERA GRIP AND SHOOTING AUXILIARY KIT

(71) Applicant: TILTA INC., Burbank, CA (US)

(72) Inventors: Sen WU, Shenzhen (CN); Hong ZHANG, Shenzhen (CN); Wenping ZENG, Shenzhen (CN); Kefeng ZHOU, Shenzhen (CN)

(21) Appl. No.: 19/072,671

(22) Filed: Mar. 6, 2025

(30) Foreign Application Priority Data
Apr. 2, 2024 (CN) 2024206727502

(51) Int. Cl. G03B 17/56

(52) U.S. Cl. CPC G03B 17/563; G03B 17/561; G03B 17/566

(57) ABSTRACT

The present disclosure provides a camera grip and a shooting auxiliary kit aimed at addressing the technical issue of jamming and impeded smoothness in the rotating structure between the camera grip and a connecting arm. The camera grip includes a handle, a connector, featuring a first end and a second end disposed opposite each other, as well as a detachable member. The first end of the connector attaches to the handle, while the second end has a first rotating connection part, situated away from the handle. One end of the detachable member is equipped with a second rotating connection part. The second rotating connection part rotates relative to and locks with the first rotating connection part. The first rotating connection part and the second rotating connection part are rotatably connected. The opposite end of the detachable member is designed to connect to a shooting device.

### CROSS-REFERENCE TO RELATED APPLICATIONS

The present application for patent claims priority to and the benefit of pending Chinese Application No. 2024206727502, filed Apr. 2, 2024, and hereby expressly incorporated by reference herein as if fully set forth below in its entirety and for all applicable purposes.

### TECHNICAL FIELD

The present application pertains to the technical field of photographic equipment auxiliaries, specifically to a camera grip and a shooting auxiliary kit.

### INTRODUCTION

Camera grips are widely utilized as auxiliary accessories for shooting devices and imaging devices. During the shooting process, photographers often adjust shooting angles according to shooting requirements such as framing and composition. Although current camera grips are equipped with rotatable connecting arms to facilitate adjustment of shooting angles, prolonged use results in significant wear and loosening of the rotating structure between the grip and the connecting arm. This leads to issues such as jamming and impeded smoothness when rotating the shooting device, significantly impacting the camera grip's service life.

### BRIEF SUMMARY

The present application introduces a camera grip and a shooting auxiliary kit aimed at addressing the technical issue of jamming and impeded smoothness in the rotating structure between the camera grip and a connecting arm.

According to aspects of the present disclosure, a camera grip is presented, comprising:
a handle;
a connector with opposing first and second ends, where the first end is connected to the handle, and a first rotating connection part is provided at the second end, distant from the handle; and
a detachable member featuring a second rotating connection part at one end that can rotate relative to and lock with the first rotating connection part. The second rotating connection part rotatably connects to the first rotating connection part, while the other end of the detachable member is designed to connect a shooting device.

### BRIEF DESCRIPTION OF THE DRAWINGS

FIG. 1 is a diagram illustrating a shooting auxiliary kit according to some aspects of the disclosure;

FIG. 2 is a diagram illustrating a camera grip according to some aspects of the disclosure;

FIG. 3 is a diagram illustrating an exploded diagram of a connector and a detachable member according to some aspects of the disclosure;

FIG. 4 is a diagram illustrating the connector of FIG. 3 according to some aspects of the disclosure;

FIG. 5 is a diagram illustrating a limiting assembly disposed within a limiting groove of the detachable member of FIG. 3 according to some aspects of the disclosure;

FIG. 6 is a diagram illustrating a cross-sectional diagram of the detachable member of FIG. 3 according to some aspects of the disclosure; and

FIG. 7 is a diagram illustrating a trigger, a first clamping arm, and a second clamping arm connected together according to some aspects of the disclosure.

### REFERENCE NUMBERS

1—shooting auxiliary kit; 2—shooting device; 100—camera grip; 200—shell; 10—handle; 21—connector; 210—first rotating connection part; 211—first connecting end; 212—second connecting end; 22—detachable member; 220—second rotating connection part; 221—mounting base; 222—clamping assembly; 2221—first elastic member; 2222—second elastic member; 2223—first clamping arm; 2224—second clamping arm; 223—triggering assembly; 2231—third elastic member; 2232—trigger; 23—limiting button; 24—limiting assembly; 241—limiting part; 242—elastic member; 243—limiting groove; 25—connecting rod; 31—first guiding surface; 32—second guiding surface.

### DETAILED DESCRIPTION

Aspects of the present disclosure are further elaborated upon through detailed description in conjunction with the drawings. Similar components across different aspects may be associated with similar component labels. In the following aspects, numerous detailed descriptions are provided to facilitate a better understanding of the present disclosure. However, those skilled in the art can readily recognize that some features can be omitted in various scenarios or replaced with other components, materials, or methods. In some instances, certain operations related to the present disclosure may not be shown or described in the specification to avoid overwhelming the core aspects of the present disclosure with excessive descriptions. Those skilled in the art can fully comprehend the related operations based on the description herein and general technical knowledge in the field.

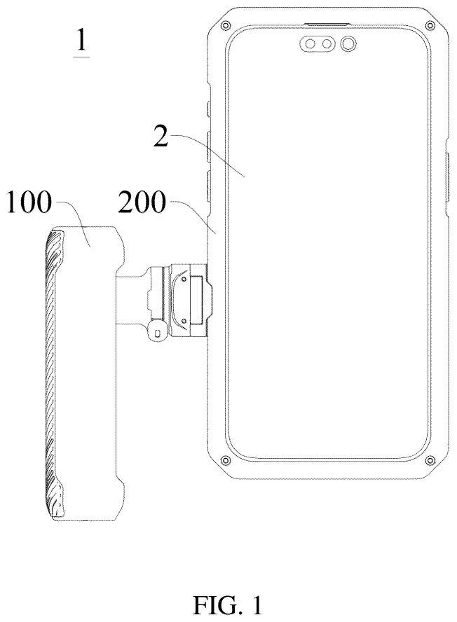

The present disclosure introduces a shooting auxiliary kit 1, for example, as depicted in FIG. 1. The shooting auxiliary kit 1 can be utilized to mount a shooting device 2, which may be a mobile phone, camera, tablet, or other similar devices. The present disclosure imposes no restrictions on the specific type of shooting device 2. The shooting auxiliary kit 1 includes a camera grip 100 and a shell 200. The shooting device 2 can be mounted in the shell 200, and the camera grip 100 can be detachably connected to the shell 200. In some aspects, the shell 200 can serve as a protective case for the shooting device 2, accommodating the shooting device 2. In some aspects, the shell 200 can be a separate shell frame, allowing the shooting device 2 to be mounted on the shell frame via clamping, insertion, screwing, or other methods. The present disclosure imposes no restrictions on the specific structure of the shell 200.

When photographers utilize the shooting device 2 for overhead, underside, tilted, or horizontal shooting, they typically need to adjust shooting angles based on requirements such as framing and composition. To achieve adjustable shooting angles, some camera grips can incorporate an internal rotating structure, which connects to the shooting device 2 via a connecting arm. However, due to the rotating structure being positioned inside the camera grip and the connecting arm having a specific length, according to the lever principle, when the camera grip is attached to the shooting device 2, the camera grip acts as the fulcrum of the connecting arm. As the length of the connecting arm increases, the moment of the gravity of the shooting device 2 is amplified at the location of the rotating structure. Over extended use, the components of the rotating structure inside the camera grip can undergo significant wear, eventually leading to loosening and/or failure.

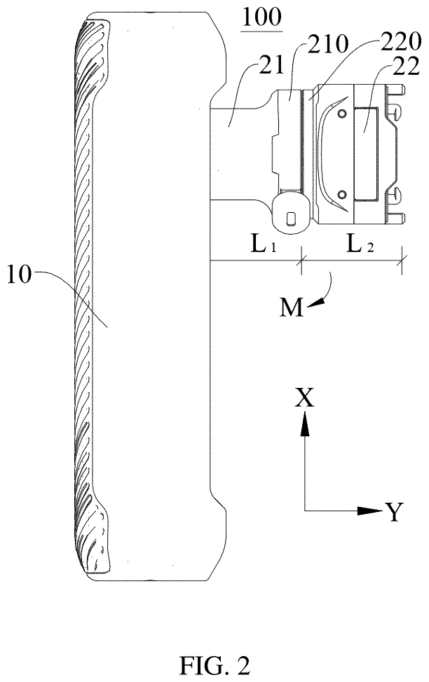

To address this issue, the present disclosure introduces a camera grip 100, for example, as depicted in FIG. 2. The camera grip 100 includes a handle 10, a connector 21, and a detachable member 22. The connector 21 features a first end and a second end arranged oppositely, with the first end capable of connecting to the handle 10. A first rotating connection part 210 is located at the second end of the connector 21, distant from the handle 10. One end of the detachable member 22 is equipped with a second rotating connection part 220 that can rotate and lock with the first rotating connection part 210. The second rotating connection part 220 connects to the first rotating connection part 210, and the other end of the detachable member 22 can be utilized to attach the shooting device 2 (e.g., as illustrated in FIG. 1).

The camera grip 100 presented in present disclosure enables the shooting device 2 to rotate relative to the handle 10 and lock in position due to the rotatable and lockable connection established between the connector 21 and the detachable member 22 via the first rotating connection part 210 and the second rotating connection part 220. Positioning the second end of the connector 21 away (e.g., spaced apart) from the handle 10 results in the connection between the first rotating connection part 210 and the second rotating connection part 220 being situated outside the handle 10. With the distance L1+L2 between the shooting device 2 and the handle 10 remaining relatively constant, the present disclosure reduces the distance L2 between the shooting device 2 and the second rotating connection part 220 (formerly, the distance between the handle 10 and the rotating structure would be L1+L2). Based on the lever principle, when the gravity of the shooting device 2 remains constant, the moment M experienced between the first rotating connection part 210 and the second rotating connection part 220 is also smaller. Therefore, apart from enabling adjustable rotation angles for the shooting device 2, the present disclosure also decreases the moment M between the connector 21 and the detachable member 22, which aids in alleviating issues such as looseness, deformation, or wear within the handle 10, thereby prolonging the lifespan of the camera grip 100.

Moreover, situating the connection between the connector 21 and the detachable member 22 outside the handle 10 eliminates the need for rotating structure-related components inside the handle 10, conserving internal space of the handle. This facilitates designing the handle 10 to better accommodate the photographer's palm or directly reducing the size of the handle 10.

In some aspects, the connection between the handle 10 and the first end of the connector 21 can be either fixed or movable. When a movable connection is employed, the connection can be in the form of sliding clamp, plug-and-play, or screw-nut mechanisms. The present disclosure does not impose restrictions on the specific connection method between the connector 21 and the handle 10.

The handle 10 can extend in length, width, and thickness directions. For example, the handle 10 can be configured in various shapes, for example, a cylindrical, bar-shaped, or tubular structure. The present disclosure does not impose restrictions on the specific shape of the handle 10. For clarity in subsequent aspects, the X-direction will be considered the lengthwise direction of the handle 10, the Y-direction as the widthwise direction, and the Z-direction (perpendicular to the X-Y plane) as the thickness direction. Thus, the handle 10 extends along the X-direction, while the connector 21, detachable member 22, and handle 10 can be connected along the Y-direction. The first rotating connection part 210 and the second rotating connection part 220 can rotate relative to each other in the X-Z plane. When photographers are shooting from overhead, below, at an angle, or horizontally, they can freely adjust the rotation angle of the shooting device 2 as needed, thereby enabling the shooting device 2 to better frame the scene.

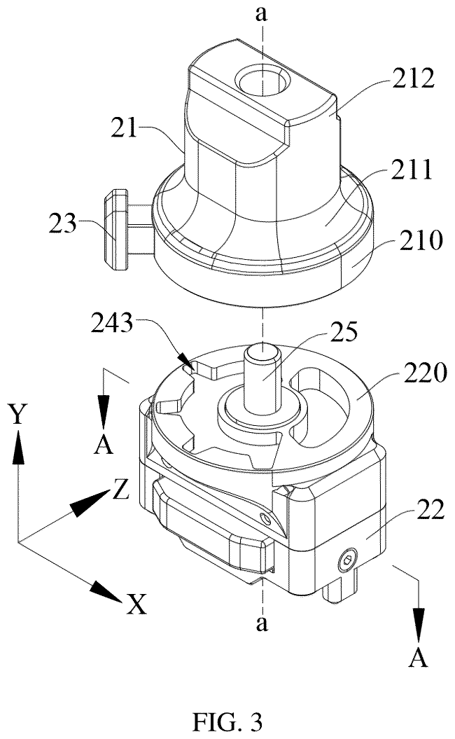

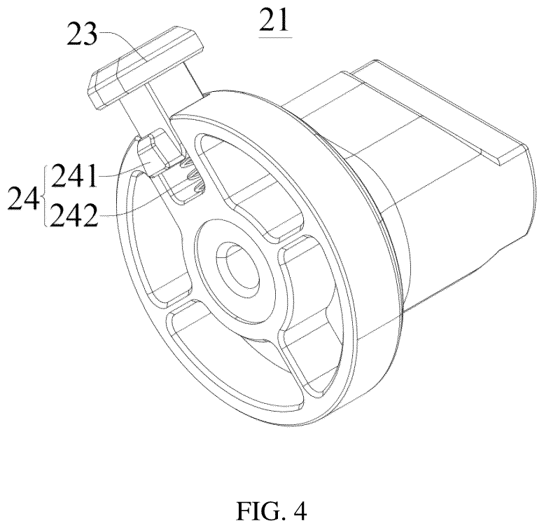

In some aspects, for example as shown in FIGS. 3 and 4, the camera grip 100 can further incorporate a limiting button 23 and a limiting assembly 24. The limiting assembly 24 can be positioned between the first rotating connection part 210 and the second rotating connection part 220. The limiting button 23 can be accessible outside the connector 21 and detachable member 22, and is connected to the limiting assembly 24. The limiting button 23 can be used to control the unlocking of the limiting assembly 24, allowing the connector 21 and detachable member 22 to rotate relative to each other. Further, the limiting button 23 can be used to control the locking of the limiting assembly 24, enabling the connector 21 and detachable member 22 to remain relatively stationary.

By positioning the limiting button 23 and the limiting assembly 24 between the first rotating connection part 210 and the second rotating connection part 220, photographers can secure the shooting device 2 at a predetermined rotation angle by operating (e.g., pressing) the limiting button 23. This facilitates fixed-angle shooting and offers a more streamlined operation. The limiting assembly 24 can manifest as a limiting latch, an end cam, or other configurations, with no restrictions on the specific structure of the limiting assembly 24 in the present disclosure.

In some aspects, as illustrated in FIGS. 3 and 4, the limiting assembly 24 includes a limiting part 241 and an elastic member 242. One of the first rotating connection part 210 and the second rotating connection part 220 features at least one limiting groove 243, while the limiting button 23 is mounted on the other and linked to the limiting part 241. The limiting button 23 enables the limiting part 241 to be disengaged from the limiting groove 243, and the elastic member 242 facilitates the resetting of the limiting part 241.

In some aspects, the limiting groove 243 can be positioned on the second rotating connection part 220, with the limiting button 23 on the first rotating connection part 210. To adjust the rotation angle of the shooting device 2, operating (e.g., pressing) the limiting button 23 moves the limiting part 241 out of the limiting groove 243, enabling relative rotation between the connector 21 and the detachable member 22. Conversely, to fix the rotation angle, the limiting part 241 moves back into the limiting groove 243 under the elastic force of the elastic member 242, thereby preventing relative rotation between the connector 21 and the detachable member 22.

In some aspects, the limiting groove 243 can be placed on the first rotating connection part 210, with the limiting button 23 placed on the second rotating connection part 220. Positioning the limiting button 23 on the connector 21 prevents the limiting button 23 from rotating with the detachable member 22, negating the need for rotation of the user's finger or hand while pressing the limiting button 23. There are no restrictions on the specific placement of the limiting groove 243 and the limiting button 23. The elastic member 242 can be a spring, a spring plate, or other configurations, with no restrictions on the specific structure of the elastic member 242.

In the present disclosure, hollow components like holes and grooves are annotated with arrowed leader lines, for example, as shown in FIG. 3, while other components use leader lines without arrows. This annotation method persists in subsequent drawings and will not be reiterated.

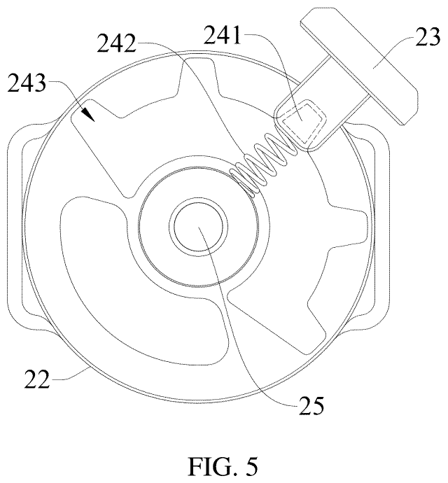

In some aspects, as depicted in FIGS. 3 to 5, the limiting button 23 is mounted on the connector 21, and capable of radial movement relative to the first rotating connection part 210. For example, the limiting button 23 can move toward or away from the central axis of the first rotating connection part 210. The elastic member 242 can be installed inside the connector 21 along the radial direction of the first rotating connection part 210, with two ends connected to the limiting button 23 and the connector 21, respectively. The limiting groove 243 is positioned inside the detachable member 22 along the radial direction of the second rotating connection part 220, with the limiting part 241 disposed within the limiting groove 243 and capable of radial movement relative to the second rotating connection part 220. Moving (e.g., pressing) the limiting button 23 towards the connector 21 causes the limiting part 241 to slide out of the limiting groove 243, while moving the limiting button 23 away from the connector 21 allows the elastic member 242 to reset the limiting part 241.

Operating (e.g., pressing) the limiting button 23 compresses the elastic member 242 along the radial direction of the first rotating connection part 210, causing the limiting part 241 to move out of the limiting groove 243. This radial actuation of the limiting button 23 facilitates easy finger operation. In some aspects, arranging the elastic member 242 along the axial direction of the first rotating connection part 210 enables an axial toggling operation mode for the limiting button 23. However, compared to radial toggling, axial toggling involves a longer finger movement, potentially causing fatigue. There are no restrictions on the operation mode of the limiting button 23 in the present disclosure.

In some aspects, for example as shown in FIG. 3, multiple limiting grooves 243 can be provided on either the first rotating connection part 210 or the second rotating connection part 220, and are spaced apart along the circumferential directions of either the first rotating connection part 210 or the second rotating connection part 220.

Providing multiple limiting grooves 243 allows the limiting part 241 to achieve multi-angle adjustment of the shooting device 2 by engaging different limiting grooves 243. For example, for a 180° transition from overhead to upward shooting, the limiting grooves 243 can be spaced half a circle apart along either the first rotating connection part 210 or the second rotating connection part 220. In some aspects, the limiting grooves 243 can be spaced a full circle apart. There are no specific restrictions on the number and spacing of the limiting grooves 243 in the present disclosure.

In certain aspects, for example, as depicted in FIG. 3, the camera grip 100 may additionally incorporate a connecting rod 25, with the axial direction a-a of the connecting rod 25 positioned centrally between the first rotating connection part 210 and the second rotating connection part 220. The connector 21 is rotatably interconnected with the detachable member 22 via the connecting rod 25.

In these configurations, the connecting rod 25 can be either a screw or a stud, enabling the first rotating connection part 210 and the second rotating connection part 220 to be threadably engaged with the connecting rod 25. This connecting rod 25 not only facilitates the connection between the connector 21 and the detachable member 22 but also permits relative rotation between the connector 21 and the detachable member 22. Alternatively, in some aspects, the connecting rod 25 may be a pivot pin, enabling the first rotating connection part 210 and the second rotating connection part 220 to be securely connected to the pivot pin while allowing controlled movement. No specific constraints are imposed on the structure of the connecting rod 25 in this disclosure.

In some aspects, for example, as illustrated in FIG. 3, the connector 21 includes a first connecting end 211 proximate to the detachable member 22 and a second connecting end 212 proximate to the handle 10. The caliber (e.g., width or diameter) of the first connecting end 211 may be larger than the caliber of the second connecting end 212, with a curved transition between the first connecting end 211 and the second connecting end 212. For example, the curved transition can be a smooth and rounded connection between the first connecting end 211 and the second connecting end 212.

Increasing the caliber of the first connecting end 211 relative to the second connecting end 212 enhances the structural strength of the connector 21, thereby improving the load-bearing capacity and ensuring the stability of the connection. The curved transition between the first connecting end 211 and the second connecting end 212 also minimizes discomfort when gripped by the user.

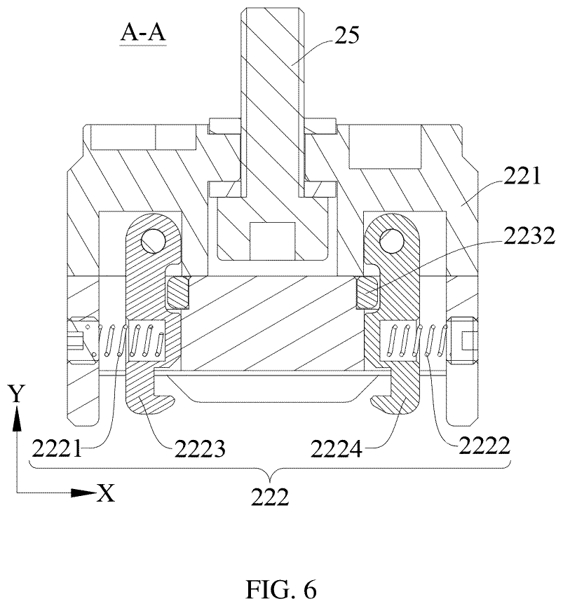

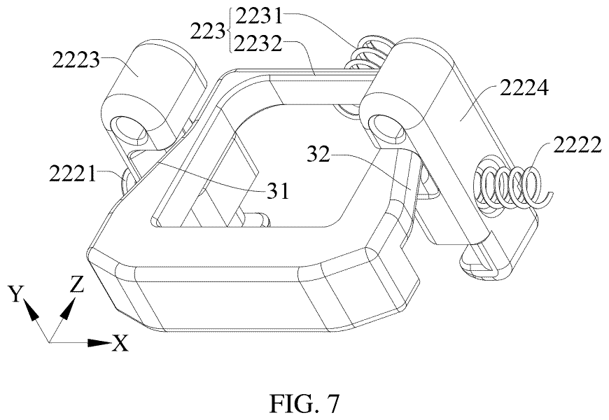

The aforementioned example provides a detailed description of the connecting mechanism between the connector 21 and the detachable member 22. To further elucidate the detachable interface between the detachable member 22 and the shell 200, the following example delves into the specific construction of the detachable member 22. As shown in FIGS. 6 and 7, the detachable member 22 includes a mounting base 221, a clamping assembly 222, and a triggering assembly 223. The clamping assembly 222, mounted on the mounting base 221, includes a first elastic member 2221, a second elastic member 2222, and oppositely positioned first clamping arm 2223 and second clamping arm 2224. The first clamping arm 2223 and the second clamping arm 2224 facilitate the clamping or release of the shell 200 for attaching the shooting device 2 (depicted in FIG. 1). The first elastic member 2221 aids in resetting the first clamping arm 2223, while the second elastic member 2222 aids in resetting the second clamping arm 2224. The triggering assembly 223, also mounted on the mounting base 221, includes a third elastic member 2231 and a trigger 2232. The trigger 2232 controls the movement of the first clamping arm 2223 and the second clamping arm 2224 towards or away from each other, with the third elastic member 2231 facilitating the reset of the trigger 2232.

In some aspects, clamping grooves corresponding to the first clamping arm 2223 and the second clamping arm 2224 may be provided on the shell 200. By actuating the trigger 2232 to bring the first clamping arm 2223 and the second clamping arm 2224 closer together, the first clamping arm 2223 and the second clamping arm 2224 can engage within the corresponding clamping grooves on the shell 200, thereby attaching the detachable member 22 to the shell 200. Conversely, to release the shell 200, actuating the trigger 2232 to move the first clamping arm 2223 and the second clamping arm 2224 farther apart disengages the first clamping arm 2223 and the second clamping arm 2224, separating the detachable member 22 from the shell 200. Here, the first elastic member 2221 can reset the first clamping arm 2223, the second elastic member 2222 can reset the second clamping arm 2224, and the third elastic member 2231 can reset the trigger 2232. In some aspects, depending on the shapes of the first clamping arm 2223 and the second clamping arm 2224 and the positions of the clamping grooves, the apart positioning of the first clamping arm 2223 and the second clamping arm 2224 can be designated as the clamping state, and the closer positioning can be designated as the releasing state. No specific constraints are imposed on the shapes of the first clamping arm 2223 and the second clamping arm 2224 in the disclosure.

In some aspects, the detachable member 22 can be configured to detachably connect to the shell 200 through methods such as threading, snapping, or sliding. The present disclosure imposes no specific restrictions on the detachable interface between the detachable member 22 and the shell 200.

In some aspects, as shown in FIGS. 6 and 7, the trigger 2232 may feature a first guiding surface 31 and a second guiding surface 32 on opposite sides of the trigger. The first clamping arm 2223 engages with the first guiding surface 31 of the trigger 2232, while the second clamping arm 2224 engages with the second guiding surface 32. Movement of the trigger 2232 drives the first clamping arm 2223 and the second clamping arm 2224 closer to or farther away from each other via the first guiding surface 31 and the second guiding surface 32.

In some aspects, as depicted in FIGS. 6 and 7, the first clamping arm 2223 and the second clamping arm 2224 are hinged within the mounting base 221, respectively. Upon application of an external force, the trigger 2232 moves in the Z-direction, causing the first clamping arm 2223 and the second clamping arm 2224 to diverge from each other under the guidance of the first guiding surface 31 and the second guiding surface 32. Upon removal of the external force, the trigger 2232 reverses its direction in the Z-direction due to the elastic force exerted by the third elastic member 2231. Subsequently, the first clamping arm 2223 returns to its initial position along the X-direction under the elastic action of the first elastic member 2221, while the second clamping arm 2224 returns to its initial position along the opposite X-direction under the elastic action of the second elastic member 2222. This mechanism facilitates the movement of the first clamping arm 2223 and the second clamping arm 2224 towards or away from each other.

In some aspects, the first guiding surface 31 and the second guiding surface 32 can be configured as wedge shapes or arcuate forms. The wedge shapes may be inclined either in the direction of the Z-axis or opposite to the Z-axis. The arcuate forms can be concave or convex arcs. No specific restrictions are imposed on the shapes of the first guiding surface 31 and the second guiding surface 32 in the present disclosure.

The aforementioned description utilizes specific examples to elucidate various aspects of the present disclosure, solely for the purpose of facilitating understanding and not for imposing limitations. Those skilled in the relevant technical field can make simple deductions, modifications, or substitutions based on the concept of the present disclosure.

What is claimed is:

1. A camera grip, comprising:
a handle;
a connector comprising a first end and a second end disposed opposite each other,
wherein the first end of the connector is connected to the handle, and the second end comprises a first rotating connection part that is situated away from the handle; and
a detachable member, a first end of the detachable member being provided with a second rotating connection part that is rotatably connected to the first rotating connection part,
wherein the second rotating connection part is configured to selectively lock with the first rotating connection part, and
wherein a second end of the detachable member is configured to connect a shooting device.

2. The camera grip according to claim 1, further comprising a limiting button and a limiting assembly connected to the limiting button;
wherein the limiting assembly is provided between the first rotating connection part and the second rotating connection part; and
wherein the limiting button is configured to transition between
an unlock state, enabling relative rotation between the connector and the detachable member, and
a lock state, securing the connector to the detachable member.

3. The camera grip according to claim 2, wherein the limiting assembly comprises a limiting part and an elastic member;
wherein one of the first rotating connection part and the second rotating connection part comprises at least one limiting groove, and the limiting button is located on other one of the first rotating connection part and the second rotating connection part, the limiting button being connected to the limiting part; and
wherein the limiting button is configured to enable the limiting part to slide out of the limiting groove, and the elastic member is configured to reset the limiting part.

4. The camera grip according to claim 3, wherein the limiting button is mounted on the connector and movable along a radial direction of the first rotating connection part;
wherein the elastic member is mounted within the connector, two ends of the elastic member are configured to abut against the limiting button and the connector, respectively;
wherein the limiting groove extends inside the detachable member, parallel to a radial direction of the second rotating connection part, configured to accommodate the limiting part;
wherein the limiting part moves along a radial direction of the second rotating connection part; and
wherein the limiting button is configured such that movement toward the connector ejects the limiting part from the limiting groove, while movement away from the connector enables the elastic member to reset the limiting part.

5. The camera grip according to claim 3, wherein a plurality of limiting grooves are provided on one of the first rotating connection part and the second rotating connection part, the plurality of limiting grooves are spaced apart at intervals along a circumferential direction of one of the first rotating connection part and the second rotating connection part.

6. The camera grip according to claim 1, further comprising a connecting rod;
wherein an axial direction of the connecting rod is aligned with a common center of the first rotating connection part and the second rotating connection part; and
wherein the connector is rotatably connected to the detachable member via the connecting rod.

7. The camera grip according to claim 1, wherein the connector comprises a first connecting end adjacent to the detachable member and a second connecting end adjacent to the handle; and
wherein the first connecting end comprises a larger caliber than the second connecting end, connected by an arcuate transition.

8. The camera grip according to claim 1, wherein the detachable member comprises:
a mounting base;
a clamping assembly mounted on the mounting base, comprising a first elastic member, a second elastic member, a first clamping arm, and a second clamping arm,
wherein the first clamping arm and the second clamping arm are configured to transition between a securing state for mounting the shooting device and a releasing state for detaching the shooting device,
wherein the first elastic member is configured to facilitate the resetting of the first clamping arm and the second elastic member is configured to facilitate the resetting of the second clamping arm; and
a triggering assembly mounted on the mounting base, comprising a third elastic member and a trigger,
wherein the trigger is configured to actuate the first clamping arm and the second clamping arm to move between a clamping state and a release state, and the third elastic member is configured to reset the trigger.

9. The camera grip according to claim 8, wherein the trigger comprises a first guiding surface and a second guiding surface;
wherein the first clamping arm abuts against the first guiding surface of the trigger and the second clamping arm abuts against the second guiding surface of the trigger; and
in response to movement of the trigger, the first guiding surface and the second guiding surface are configured to drive the first clamping arm and the second clamping arm to move toward or away from each other.

10. A shooting auxiliary kit, comprising:
the camera grip according to claim 1, detachably connected to a shell for mounting a shooting device.
